(19) United States
(12) Patent Application Publication
(10) Pub. No.: US 2004/0116146 A1
(43) Pub. Date: Jun. 17, 2004

(54) Cellular system with link diversity feedback

(76) Inventors: John S. Sadowsky, Mesa, AZ (US); Daniel Yellin, Raannana (IL); David Ben-Eli, Modiin (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/318,879

(22) Filed: Dec. 13, 2002

(51) Int. Cl. H04Q 7/20

(52) U.S. Cl. 455/525; 455/423

(57) ABSTRACT

A communication system has base stations, a network controller and mobile stations. Over-the-air signal structures allow diversity methods to be employed with diversity combining done at a receiver of one of the mobile stations. A feedback mechanism reports base-to-mobile channel information including the diversity state back to the network to control the efficiency of the mobile.

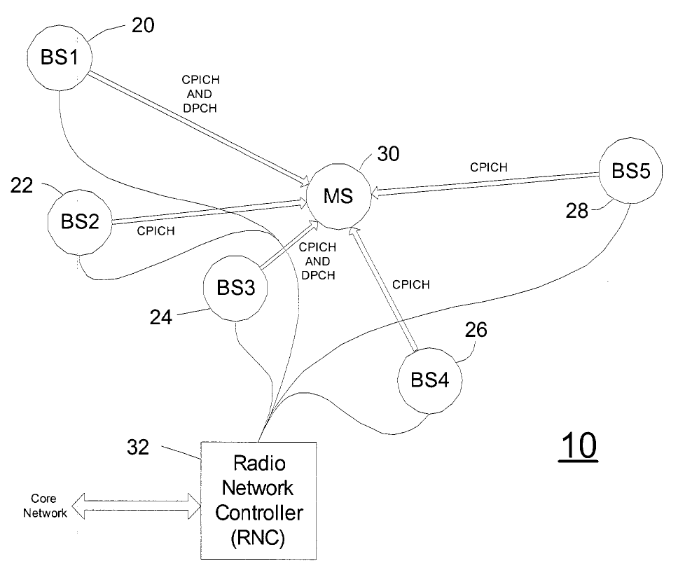

A mobile communication device within a cellular system typically receives overlapping data-bearing signals associated with a plurality of users within the system. Some of the users may be located within a cell common with the mobile communication device, while other users may be located in other cells. The mobile communication device extracts data from the composite received signal. Signal components other than the component carrying the local user data are considered interference by the mobile communication device because they interfere with the data extraction process.

Techniques used to extract the transmitted information rely on cross-correlation features of the different code sequences to separate the different users. Asynchronous users and multi-path propagation differences may cause multiuser interference and fading, resulting in a disruption in the detection of desired signals. Accordingly, with interference and multi-path propagation a need exists for improving the methods of communication between a mobile device and base stations.

### BRIEF DESCRIPTION OF THE DRAWING

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

The sole FIGURE illustrates a cellular communication system where a mobile station provides diversity information to the Radio Network Controller (RNC) and base stations in accordance with the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the present invention may be used in a variety of applications, with the claimed subject matter incorporated into microcontrollers, general-purpose microprocessors, Digital Signal Processors (DSPs), Reduced Instruction-Set Computing (RISC), Complex Instruction-Set Computing (CISC), among other electronic components. The present invention may also be incorporated into smart phones, communicators and Personal Digital Assistants (PDAs), base band and application processors, platform OS based devices, automotive infotainment and other products. However, it should be understood that the scope of the present invention is not limited to these examples.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In a cellular communication system, multiple base stations provide wireless communication services to mobile users within the system. Base stations typically service multiple mobile users within a coverage region or cell associated with the base station. A base may have multiple transmit-receive elements that divides the cell into sectors. To allow multiple users to share a base station, multiple access schemes may be employed.

One multiple access scheme is Code Division Multiple Access (CDMA) that uses a plurality of substantially orthogonal codes or nearly orthogonal codes to spread spectrum modulate user signals within the system. Each modulated user signal has an overlapping frequency spectrum with other modulated user signals in the system. However, because the underlying modulation codes are orthogonal (or nearly-orthogonal), each user signal is capable of being independently demodulated by performing a correlation operation on the composite signal using an appropriate code.

The sole FIGURE illustrates a cellular communication system 10 in which the principles of the present invention may be practiced, and in particular, where a mobile station 30 generates diversity information that may be supplied to the network through a Radio Network Controller (RNC) 32. Cellular communication system 10 may be a Code Division Multiple Access (CDMA) cellular network such as IS-95, CDMA 2000, UMTS-WCDMA and include a plurality of Base Stations (BS) 20, 22, 24, 26 and 28 that may be distributed within an area and provide coverage in cells for wireless communication with mobile users. The terms “Radio Network Controller” (RNC), “Common Pilot Channel” (CPICH) and “Dedicated Physical Channel” (DPCH) are specific terms used in UMTS-WCDMA specifications. These terms are used in a generic sense and are taken to apply to any functionally similar elements of other networks.

Cellular communications systems must operate in a variety of channel conditions. The signals may be corrupted by multiple propagation paths that may combine destructively, resulting in deeply faded signal strength at the mobile receiver. In addition, pedestrian or vehicular motion induces Doppler frequency shifts on multipath components, resulting in a time variation of the faded multi-path channel. This combination of Doppler and multiple propagation paths is commonly called multipath fading.

Diversity techniques are the first line of defense against multipath fading in modern cellular systems including GSM/(E)GPRS, CDMA2000 and WCDMA. In the abstract definition, diversity simply means that multiple copies of the signal, or signal redundancies as might be generated by a coding system, are transmitted over multiple loosely correlated fading channels. These loosely correlated channels are called “diversity channels.” The redundant energy is combined at the receiver. While deep fades will occur frequently on individual diversity channels, loss of data occurs only when there are simultaneous deep fades over multiple diversity channels, which is rare event.

A type of diversity that is used in many cellular systems is time diversity. In this method, Forward Error Correction (FEC) communicates data that corrects errors in transmission on the receiving end, usually using a convolutional code to add redundancy to the bit stream. These coded bits are interleaved and transmitted over a rapidly fading channel. Time diversity occurs when the fading time constant (called the “coherence time” of the channel) is small relative to the transmission time of the coded block. In this case, the “diversity channels” are short time segments of coded block transmission time intervals. Some of the time segments may be deeply faded, but the faded symbols are de-interleaved and distributed across the block in a manner that may be corrected by the FEC decoder.

CDMA systems employ multiple types of diversity. The inherently wideband nature of the signal structure allows the receiver to resolve the multipath structure of the propagation channel. A receiver may resolve and independently track individual multipath components of the received signal and then combine these received energies. The “diversity channels” are the individually resolved multipath components. In CDMA, the common receiver structure that facilitates multipath diversity is the RAKE receiver. RAKE receiver elements that may be tuned to specific multipath components are called RAKE fingers.

The base-to-mobile link of a CDMA system employs a Common Pilot Channel (CPICH). The CPICH is a signal that is modulated with only the CDMA scrambling code (PN code) and a channelization code so the signal is completely known to the mobile receiver. The receiver uses this pilot signal for channel estimation to allow coherent demodulation. For example, in a RAKE receiver channel estimation is performed for each multipath finger. In addition, the common pilot may also be used to make measurements of received power levels in adjacent cells or adjacent sectors. These measurements are often fed back to the RNC via an uplink control channel and are used by the network to make cell/sector handoff decisions.

In some systems, it is possible to have more than one active set that services the user of mobile station 30 during, for example, soft-handoff operations. Soft-handoff refers to the overlapping of base station coverage zones in CDMA systems so that every mobile station (cell phone set) is well within range of at least one base station. The term “active set” refers to a base station or sector that is presently providing communication services to a particular user or mobile station 30. For example, base station 20 may be acting as the active set for mobile station 30 that is located within the cell serviced by that base station.

In some cases, mobile stations transmit signals to, and receive signals from, more than one base station at a time. Thus, mobile station 30 receives signals from a number of the active set of base stations 20 within system 10. Since soft handoff involves transmission of the same signal content from multiple base stations, or multiple transmitting sectors of the same base, it is a form of diversity. This is often called macro-diversity.

Base stations 22, 24, 26 and 28 may be coupled to a base station controller or Radio Network Controller (RNC) 32 by any of a variety of wired connections including, for example, Local Area Data Access (LADA) lines, T1 or fractional T1 lines, Integrated Services Digital Network (ISDN), Basic Rate Interface (BRI), cable TV lines, fiber optic cable, digital radio, microwave links, or private lines, although the type of connection is not intended to limit the scope of the present invention. In addition, RNC 32 may be connected to one or more networks such as, for example, a Public Switched Telephone Network (PSTN), Internet or X.25 network, via any variety of network links.

Soft-handoff may be controlled and managed by RNC 32. Each of base stations 20, 22, 24, 26 and 28 transmit a CPICH signal that is received by mobile station 30 and used for detection, synchronization, channel estimation, and in general, as an aid in the detection of the corresponding data-bearing signals. In particular, the FIGURE illustrates that mobile station 30 monitors transmissions from base stations 20, 22, 24, 26 and 28 and performs strength measurements on the CPICH signal received from these multiple base stations.

CPICH power measurement reports to the RNC, via mobile-to-base control channels, is a primary example of how a network controller may employ mobile feedback to control an aspect of diversity. It is emphasized here that the common practice is to use power measurements for soft handoff control.

Macro diversity in CDMA base-to-mobile communications is usually accommodated using a RAKE. Additional fingers are assigned to the affiliated base or sector transmitters, the number assigned per transmitter being determined by the amount of multipath on the associated propagation channel.

There is an important distinction to be made between the two types of CDMA diversity discussed above. Macro diversity may be controlled by the network. Multipath diversity is governed by the nature of the physical propagation channel. The amount of multipath present is known by the mobile receiver, but is not inherently known to the network.

Diversity methods in general are a powerful way to combat channel fading. However, there is a phenomenon of diminishing returns. Diversity equivalent to 2 or 3 purely uncorrelated channels provides great performance gains relative to no diversity, but beyond that the gains are incremental. In addition, exploiting diversity at the receiver requires receiver resources. For example, multipath and macro diversity require multiple receiving elements (RAKE fingers).

Too much diversity can actually be detrimental. If the total potential diversity in the over-the-air signal at the receiver antenna overwhelms the receiver's resources, then some portion of the signal energy impinging on the receiver is not recovered by the receiver. This unrecoverable energy is just interference to the network, which ultimately results in a lower network capacity than would be obtainable if all receivers were operating at 100% efficiency.

Thus, in an interference limited cellular system, such as any CDMA system, it is important that all receivers operate at near peak efficiency. This is particularly important in the base-to-mobile link as it is highly desirable to contain mobile receive cost and power consumption, and hence, mobile receiver resources are limited. In accordance with this invention, the network requires feedback through a feedback command signal from the mobile to manage the amount of diversity applied to given mobiles. By managing the amount of diversity, the network may optimize the trade between richness of diversity offered to individual mobiles, mobile receiver resources and network capacity.

In accordance with one feature of the present invention, mobile station 30 provides uplink signaling through the feedback command signal to RNC 32 that includes figure-of-merit data that indicates (in addition to signal strength measurements) the amount of multipath diversity for each of base stations 20, 22, 24, 26 and 28. RNC 32 may then use this information to select an active set of base stations to transmit data to mobile station 30 in a soft-handoff operation. By way of example, suppose that base stations 20, 22 and 24 have the strongest received signal power at the mobile, and all have comparable power levels. However, base stations 20 and 24 may have rich multipath diversity, while base station 22 does not. For this reason, RNC 32 selects only base stations 20 and 24 as the active set, as indicated by the Dedicated Physical Channel (DPCH) on these links in the FIGURE. In such an example, it is possible that the addition of base station 22 would overwhelm the mobile receiver with too much diversity, resulting in operation at less than peak efficiency. This situation may be avoided using the features of the present invention because with the addition of feedback diversity, RNC 32 may predict and control the amount of diversity to be present at the mobile. Thus, the diversity measurement feedback, in addition to received signal power, allows RNC 32 to better optimize the active set decisions across the network.

RNC 32 may take other diversity system concepts into account. Diversity systems are a collection of techniques that improve the Quality of Services (QoS) and the capacity of the system while maintaining a minimum quality. Although the system performance of current wireless communication systems may be limited by channel impairments such as signal fading, Inter-Symbol Interference (ISI) and cochannel interference, the performance of the system may be improved using diversity techniques. By way of example, signal fading and ISI may arise from multi-path propagation, while interference may generally be caused by cochannel users in the network. To mitigate signal fading, diversity schemes such as spatial diversity, polarization diversity, frequency diversity and time diversity may be measured by mobile station 30, and in embodiments of the present invention, the network and RNC 32 in particular may receive figure-of-merit data generated by mobile station 30 as feedback on an uplink control channel to indicate the diversity state of the downlinks. In this manner, characterization of link diversity may be used to improve communication between base stations 20, 22, 24, 26 and 28 and mobile station 30.

To alleviate cochannel interference, interference cancellation techniques such as adaptive beamforming or multiuser detection may be used to reduce the interference. Adaptive beamforming is generally used when information about the interference is not available. Multi-user detection is generally possible when information about the interference is known to the receiver. Figure-of-merit data may be generated by mobile station 30 as the combination of adaptive beamforming with multiuser detection and supplied to the network depicted in cellular communication system 10 to improve performance.

One diversity measurement that may be performed by mobile station 30 involves the level of multi-path associated with various base stations. Mobile station 30 may receive signals having a number of different transmission paths referred to as a direct path, a reflected path and a refracted or scattered path. In the direct path, energy may travel unimpeded from the point of origin at the base station to reception by the mobile station. In the reflected path, energy may strike an object and be reflected to the point of reception. In the refracted path, the energy may be dispersed from a surface edge as secondary or refracted energy. In the scattered path, energy may strike an object and scatter in all directions.

Consequently, different operational environments such as an indoor office environment, an outdoor pedestrian environment and a vehicular environment generate transmission paths that experience different fading characteristics. Mobile station 30 constructs a composite message by selection or combination of channels to reduce fade-induced distortion and further provides a figure-of-merit for feedback to the network and RNC 32. The figure-of-merit information used in the algorithm processed by RNC 32 may direct the appropriate base stations in the network in making soft-handoff decisions.

Another diversity measurement that mobile station 30 may generate and supply to the network involves figure-of-merit data based on the criteria of Signal-to-Noise Ratio (SNR) for signals received from two different base stations. The SNR figure-of-merit data processed in the algorithm run in RNC 32 may direct the decision on which base stations to include within the active set. RNC 32 may favor the base station whose signal is being received having a high SNR.

Figure-of-merit data for Orthogonal Transmit Diversity (OTD) may be supplied by mobile station 30 to the network. Space diversity or smart-antennas systems make use of multiple antennas working simultaneously in time and frequency. OTD may be used when a base station splits the coded and interleaved bits into different streams for simultaneous transmission over different transmit antennas. Two or more transmitting antenna may be used, with different spreading codes used for the streams to maintain the orthogonality. In addition to a normal pilot on one antenna, an auxiliary pilot may be transmitted on the second antenna to aid in coherent detection at the receiver of mobile station 30. This mechanism may provide important gains in environments with severe fading and very short multi-path delay spreads so that the receiver may only resolve one multipath component, and availability of soft handoff is limited. In such cases, in accordance with this invention, the mobile may either request switching to an OTD mode, or it may provide the channel diversity feedback that allows RNC 32 to make the OTD decision.

Alternatively, signals may be transmitted from a single source that are received at multiple spaced-apart antennas and combined, a process referred to as space diversity. Micro-diversity is one form of space diversity that exists when two or more receiving antennas are located in close proximity to each other and where each antenna receives the signals from the single source. In micro-diversity systems, the received signals from the common source are processed and combined to form an improved quality resultant signal for that single source. The terminology micro-diverse locations means, therefore, the locations of antennas that are close together and that are only separated enough to be effective against fading or similar disturbances. Mobile station 30 may generate figure-of-merit data for the various forms of space diversity and provide feed back to RNC 32 that allows the network to make decisions to improve the QoS of communications system 10.

Optionally, Time Switched Transmit Diversity (TSTD) may be implemented in the transmitter of base stations 20, 22, 24, 26 and 28. But unlike OTD where at least two antennas are used all the time, a user in TSTD transmits from only one antenna at any instant of time. Different users may shift between the antennas and use different pseudo random switching patterns. Switching the users pseudo randomly may equalize the use of both antenna and reduce the capacity and crest factor of the power amplifiers used by the base stations in transmitting signals. As in the case of OTD, two different pilots may be used for coherent detection. A pilot-tracking unit (not shown) in mobile station 30 despreads each pilot signal from the base stations being tracked and performs continuous time tracking and channel tracking (i.e., amplitude and phase estimation) for the signal. A searcher unit (not shown) in mobile station 30 may also search for new pilot signals within the received signal. The diversity information generated by the pilot tracking unit and the searcher unit may be delivered to the network for use by the network in making soft-handoff decisions.

Figure-of-merit data for Selective Transmit Diversity (STD) may also be generated and supplied by mobile station 30 to the network and RNC 32. Ideally, it is desired that an antenna be selected for transmission that yields the highest received SNR. However, the base station transmitter does not know the state of the channel between the base station and mobile station 30. Hence, a feedback channel may be used from mobile station 30 to RNC 32, indicating an STD figure-of-merit, which may allow RNC 32 to select the antenna that provides a higher SNR. The figure-of-merit data allows the network to determine which base station may be the best to transmit information to mobile station 30.

CDMA may use space-time concepts to exploit path diversity in scattering environments in order to provide improved capacity. A space-time method (STTD) may exploit the multi-path diversity between multiple antennas at both ends, i.e., either at the transmitter or the receiver or both, so that the channel may be viewed as a Multiple-input Multiple-Output (MIMO) system. Mobile station 30 may generate figure-of-merit data that may be transferred to the network and used to improve communication performance and QoS.

By now it should be apparent that figure-of-merit data may be generated and supplied by each individual mobile station 30 to RNC 32 to account for various types of diversity. The figure-of-merit data may be accounted for in the algorithm run in RNC 32 that allows the network to make decisions to enhance or improve the QoS of mobile station 30. This allows mobile station 30 to instruct the network, based on its knowledge of the channel conditions and channel interference, as to which diversity transmission technique each of the base stations should use. Mobile station 30 may generate macro-diversity information that is supplied to the network to influence the soft handoff decisions and point to the base station with whom to perform the soft handoff. Or, mobile station 30 may generate and supply figure-of-merit data on space-time diversity (via STTD), joint space-macro-diversity (via SSDT), or beamforming that may be fed back to the network. Note that in general, mobile station 30 has more knowledge about its channel and interference conditions that the base stations, and therefore, may appropriately instruct the network and allow RNC 32 to decide on the most efficient diversity transmission methods to use in communications system 10.

What is claimed is:

1. A network comprising:
a plurality of base stations;
a network controller coupled to the plurality of base stations; and
a mobile station to receive an over-the-air signal and allow diversity methods to be employed with diversity combining done at a receiver of the mobile station, where a feedback command signal from the mobile station requests an increase or decrease of diversity quantity in the over-the-air signal.

2. The network of claim 1 wherein the feedback command signal further requests a diversity mechanism from one of the plurality of base stations in the over-the-air signal.

3. The network of claim 1 wherein one of the plurality of base stations receives the feedback command signal from the mobile station and the network manages an amount of diversity supplied to the mobile station and other mobile stations in accordance with the feedback command signal.

4. The network of claim 1 wherein the network optimizes an amount of diversity offered to the mobile station based on receiver resources specified by the mobile station to the network.

5. A network having base stations, a network controller coupled to the base stations and a plurality of mobile stations, the network comprising:
a receiver of one of the plurality of mobile stations to receive an over-the-air signal, where the receiver allows diversity methods to be employed with diversity combining; and
a feedback signal that reports diversity information of a base-to-mobile channel and diversity combining capabilities of the receiver.

6. The network of claim 5 wherein base-to-mobile channel information supplied to the network controller includes a reporting a number of multipath receiving elements in the one of the plurality of mobile stations.

7. The network of claim 5 wherein base-to-mobile channel information supplied to the network controller increases or reduces the diversity in the over-the-air signal.

8. The network of claim 5 wherein the network optimizes an amount of diversity offered to other mobile stations in the plurality of mobile stations based on receiver resources specified by the mobile station to the network.

9. The network of claim 5 wherein the network optimizes an amount of diversity offered to the mobile station.

10. The network of claim 5 wherein the diversity feedback signal allows the network controller to optimize active set decisions across the network.

11. The network of claim 5 wherein the base-to-mobile channel information includes diversity measurements based on the conditions of the channels.

12. The network of claim 5 wherein the diversity information includes diversity information of base stations not in an active set.

13. A communications network, comprising:
a plurality of base stations in the communications network;
a network controller coupled to the plurality of base stations; and
a mobile in the communications network to make diversity measurements based on channel conditions and interference of signals received from the plurality of base stations, wherein information about the diversity measurements is supplied to the network controller to control diversity in a selected base station in the communications network.

14. The communications network of claim 13, wherein the information about the diversity measurements supplied to the network controller include diversity measurements on adjacent cells that are not currently in communication with the mobile.

15. The communications network of claim 13, wherein diversity reports made by the mobile influence selection of diversity methods such as space-time diversity (STTD) data, space-macro-diversity (SSDT) data, and beamforming in the RNC.

16. The network of claim 13 wherein the information about the diversity measurements supplied to the network controller is used to control the diversity of base stations not in an active set.

17. A method, comprising:
continuously tracking channel information in an over-the-air signal to dynamically generate diversity information in a mobile; and
supplying the diversity information in a feedback command signal to a network to increase or decrease diversity quantity in the over-the-air signal.

18. The method of claim 17, further including:
receiving diversity information through the feedback command signal from the mobile that allows a network controller to change diversity that a base station provides to the mobile in an the over-the-air signal.

19. The method of claim 17, further including:
managing a network to control an amount of diversity supplied to the mobile station and other mobile stations in accordance with the feedback command signal.

20. The method of claim 17, further including:
optimizing an amount of diversity offered to the mobile based on receiver resources specified by the mobile station to a network.

21. The method of claim 17, further including:
using the diversity information received in a network to control soft-handoff decisions.

22. The method of claim 17, further including:
optimizing an amount of diversity information offered to the mobile-based on network capacity.
